(19) United States
(12) Patent Application Publication
(10) Pub. No.: US 2019/0259244 A1
(43) Pub. Date: Aug. 22, 2019

(54) SYSTEMS AND METHODS FOR CONDUCTING A WAGER GAME

(71) Applicant: GAMING ENTERTAINMENT SYSTEMS PTY LIMITED, Hornsby (AU)

(72) Inventors: Simon Maclaren WITTY, Hornsby (AU); Harley David JACKSON, Hornsby (AU)

(73) Assignee: GAMING ENTERTAINMENT SYSTEMS PTY LIMITED, Hornsby (AU)

(21) Appl. No.: 16/399,693

(22) Filed: Apr. 30, 2019

Related U.S. Application Data
(63) Continuation of application No. 15/127,157, filed on Mar. 6, 2017, now abandoned.

(30) Foreign Application Priority Data
Mar. 18, 2014 (AU) 2014900933

(51) Int. Cl. G07F 17/32

(52) U.S. Cl. CPC G07F 17/3288; G07F 17/3227; G07F 17/326; G07F 17/322; G07F 17/3244; G07F 17/3211

(57) ABSTRACT

A method of playing a side game concurrently playable with a game of roulette includes accepting side bet wagers from players in a first side game during a wager phase for the game of roulette. The side bet wagers are independent of wagers placed on the roulette game. Two or more side game symbols are selected from a first symbol set which are playable in the game of roulette. Each of the side game symbols are assigned a payout value, such that at least one of the assigned payout values is a fixed payout value utilized for each play of the side game and another of the assigned payout values is a variable payout value. A determination is made if any of the selected side game symbols match a winning roulette symbol. Side game prizes are awarded to winning side bet players according to the corresponding assigned payout value.

### CROSS-REFERENCE TO RELATED APPLICATIONS

This application is a Continuation of U.S. patent application Ser. No. 15/127,157 filed Mar. 6, 2017 which is the U.S. national phase of PCT Application No. PCT/AU2015/050115 filed on Mar. 18, 2015, which claims priority to AU Patent Application No. 2014900933 filed on Mar. 18, 2014, the disclosures of which are incorporated in their entirety by reference herein.

### FIELD OF THE INVENTION

The present invention relates to gaming systems, game controllers and methods of gaming. It particularly relates to a side wager game that is playable concurrently with a game of roulette.

### BACKGROUND OF THE INVENTION

Roulette is one of the most popular gambling games worldwide. Despite its popularity, one drawback of the game is the limited maximum payout possible, that being 35-1 on a straight-up result. Players are attracted to the possibility of a high payout as indicated by the popularity of games such as casino poker and Sic Bo, which offer maximum payouts typically in the range of 100 to 1 to 150 to 1, and even higher in some casinos.

It would be advantageous if there was provided a way in which players of a roulette game could be offered the possibility of a large payout of a similar magnitude to poker or Sic Bo.

### SUMMARY

In accordance with a first aspect there is provided a method of conducting play of a side game which is concurrently playable with a game of roulette, the method comprising: during a wager phase for the game of roulette, accepting side bet wagers from players in respect of a first side game, the side bet wagers being independent of wagers placed on the roulette game; selecting two or more side game symbols from a first symbol set comprising symbols that are playable in the game of roulette; assigning each of the selected side game symbols a payout value, such that at least one of the assigned payout values is a fixed payout value utilized for each play of the side game and another of the assigned payout values is a variable payout value; determining a winning symbol for the game of roulette; determining whether the winning symbol matches any of the selected side game symbols; and responsive to determining that the winning symbol matches one of the selected side game symbols, awarding a side game prize to each player who placed a side bet wager according to the corresponding assigned payout value.

In an embodiment the variable payout value is selected from a set of payouts, the set including a bonus payout value which is of greater value than the other payout values in the set.

In an embodiment the selection of variable payout value is made such that the bonus payout value has a lower likelihood of being selected than the other payout value(s) in the set.

In an embodiment the method further comprises displaying the variable payout value and/or selected side game symbols after the wager phase has concluded.

In an embodiment the selected side game symbols are displayed after the wager phase has concluded and before the winning symbol for the game of roulette is drawn.

In an embodiment the first symbol set comprises a subset of the symbols which are playable in the game of roulette.

In an embodiment at least one of the selected side game symbols is randomly selected from the first symbol set.

In an embodiment the method further comprises applying a weighting to the random selection of side game symbols such that at least one of the symbols in the first symbol set is more likely to be selected than another of the symbols.

In an embodiment one of the symbols in the first symbol set is selected for each play of the side game.

In an embodiment the one symbol selected for each play of the side game is assigned the variable payout value.

In an embodiment the method further comprises accepting side bet wagers from players on an alternative side bet outcome, the alternative side bet outcome determined by selecting an additional two or more symbols from a second symbol set, wherein the first and second symbol sets comprise a mutually exclusive subset of symbols that are playable in the game of roulette and wherein responsive to determining that the winning symbol matches one of the additional symbols players that placed side bet wagers on the alternative side bet outcome are awarded a side bet prize.

In an embodiment the first symbol set comprises a selection of symbols determined as winning symbols at least a predefined number of times within a preceding predefined number of games, the predefined number of times and games each being greater than 1.

In an embodiment the second symbol set comprises a selection of symbols that have been determined as winning symbols less than or equal to a predefined number of times within a preceding predefined number of games.

In an embodiment the selected side bet symbols comprise the winning roulette symbol from the preceding game and at least one symbol located either side of the winning roulette symbol on the roulette wheel.

In an embodiment the method further comprises selecting five side bet symbols comprising the winning roulette symbol from the preceding game of roulette and the two symbols located on either side of the winning roulette symbol on the roulette wheel.

In an embodiment the method further comprises allocating the variable payout value to the winning symbol from the preceding game.

In an embodiment the method further comprises allocating each of the symbols located on either side of the winning symbol fixed payout values.

In an embodiment the two or more selected side bet symbols correspond to the winning symbols from the fewest number of immediately preceding plays of the roulette game required to generate a unique set of side game symbols.

In accordance with a second aspect there is provided a method of conducting play of a side game which is concurrently playable with a game of roulette, the method comprising: during a wager phase for the game of roulette, accepting side game wagers from players; selecting two or more side game symbols for use in determining the first side game outcome, the side game symbols being selected from a first symbol set comprising symbols that are playable in the game of roulette; assigning a payout value to each selected side game symbol, each payout value being randomly selected from a respective set of payouts having values within a predefined range and wherein at least one of the respective sets has a different predefined range to another of the sets, determining a winning symbol for the game of roulette; and responsive to determining that the winning symbol matches one of the selected side game symbols, awarding a prize to each player who placed the side game wager according to the payout value corresponding to the matched side game symbol.

In accordance with a third aspect there is provided an apparatus for facilitating play of a side game which is concurrently playable with a game of roulette, the method comprising: a device for receiving side bet wagers from players during a wager phase for the game of roulette; a device for determining a winning roulette symbol once the wager phase has concluded; a gaming controller operable to select two or more side game symbols, the side game symbols being selected from a first symbol set comprising symbols that are playable in the game of roulette, the gaming controller being further operable to assign each of the selected symbols a payout value such that at least one of the assigned payout values is a fixed payout value utilized for each play of the side game and another of the assigned payout values is a variable payout value, wherein responsive to determining that the winning symbol matches one of the selected side game symbols, a prize is awarded to each player who placed the side game wager according to the payout value assigned to the matching symbol.

In an embodiment the variable payout value is selected from a set of payout values, the set including a bonus payout value of greater value than each of the other payout values in the set.

In an embodiment the selection of variable payout value is made such that the bonus payout value has a lower likelihood of being selected than the other payout value(s) in the set.

In an embodiment the method further comprises a display module operable to display the assigned payout values to the players.

In an embodiment the selected side game symbols and/or variable payout value is displayed after the wager phase has concluded and before the winning symbol for the game of roulette is drawn.

In an embodiment the first symbol set comprises a subset of the symbols which are playable in the game of roulette.

In an embodiment at least one of the side game symbols is randomly selected from the first symbol set.

In an embodiment the symbol selector module is further operable to apply a weighting to the random selection of side game symbols such that at least one of the symbols in the first symbol set is more likely to be selected than another of the symbols.

In an embodiment one of the symbols in the first symbol set is selected for each play of the side game. The one symbol selected for each play of the side game may be assigned the variable payout value.

In an embodiment the apparatus is further configured to accept side bet wagers from players on an alternative side bet outcome, the alternative side bet outcome determined by drawing an additional two or more symbols from a second symbol set, wherein the first and second symbol sets comprise a mutually exclusive subset of symbols that are playable in the game of roulette and wherein, responsive to determining that the winning symbol matches one of the additional symbols, players that placed side bet wagers on the alternative side bet outcome are awarded a side bet prize.

In an embodiment the first symbol set comprises a selection of symbols determined as winning symbols at least a predefined number of times within a preceding predefined number of games, the predefined number of times and games each being greater than 1.

In an embodiment the second symbol set comprises a selection of symbols that have been determined as winning symbols less than or equal to a predefined number of times within a preceding predefined number of games.

In an embodiment the two or more selected side bet symbols comprise the winning symbols from the fewest number of immediately preceding plays of the roulette game required to generate a unique set of selected side game symbols.

In accordance with a fourth aspect there is provided a method of conducting play of a side game which is concurrently playable with a game of roulette, the method comprising: during a wager phase for the game of roulette, accepting side game wagers from players; selecting two or more side game symbols for use in determining the side game outcome, the side game symbols being selected from a first symbol set comprising symbols that are playable in the game of roulette; determining a winning symbol for the game of roulette; determining whether the winning symbol matches any of the selected side game symbols; and responsive to determining that the winning symbol matches one of the selected side game symbols, awarding a prize to each player who placed the side game wager based on a payout value assigned to the matching symbol.

In an embodiment the payout value is determined based, at least in part, whether any of the other selected side game symbols matched winning roulette symbols from a predefined number of preceding plays of the roulette game. In an embodiment the predefined number of preceding plays is n−1, where n is the number of selected side game symbols. In an embodiment the payout value increases relative to the number of matches for the other selected side game symbols. In an embodiment the number of symbols selected for use in determining the side game is four.

In accordance with a further aspect there is provided a method of conducting play of a side game which is concurrently playable with a game of roulette, the method comprising: during a wager phase for the game of roulette, accepting side bet wagers from players on a first side game outcome; once the wager phase has concluded, selecting two or more side game symbols for use in determining the first side game outcome, the side game symbols being selected from a first symbol set comprising symbols that are playable in the game of roulette; randomly determining a winning symbol for the game of roulette; and responsive to determining that the winning symbol matches one of the selected side game symbols, awarding a prize to each player who placed a side bet wager, wherein a value of the prize is determined by evaluating a pay table listing payout values for each selected side game symbol, the payout values being set for each play of the side game such that at least one of the selected side game symbols is assigned a fixed payout value and another of the selected symbols is assigned a variable payout value which is randomly selected from a predefined list of payout values.

In an embodiment one of the payout values in the predefined list has a substantially greater value than each of the other payout values in the list, with respect to the fixed payout value.

In an embodiment the method further comprises applying a weighting to the random selection of payout values such that the probability of selecting the substantially greater payout value is less than that for selecting the other payout values.

In accordance with a still further aspect there is provided a method of conducting play of a side game which is concurrently playable with a game of roulette, the method comprising: during a wager phase for the game of roulette, accepting side game wagers from players on a first side game outcome; once the wager phase has concluded, selecting two or more side game symbols for use in determining the first side game outcome, the side game symbols being selected from a first symbol set comprising symbols that are playable in the game of roulette; randomly selecting a winning symbol for the game of roulette; and responsive to determining that the winning symbol matches one of the selected side game symbols, awarding a prize to each player who placed the side game wager, wherein a value of the prize is determined by evaluating a pay table listing payout values for each selected side game symbol, the payout values being set across a series of plays of the side game such that a first set of payouts having a first overall payout value is assigned to all but one of the plays which is assigned a second set of payouts having a greater overall payout value to the first overall payout value.

In accordance with a still further aspect there is provided a method of conducting play of a side game which is concurrently playable with a game of roulette, the method comprising: during a wager phase for the game of roulette, accepting side game wagers from players on a side game outcome; once the wager phase has concluded, randomly selecting two or more side game symbols for use in determining the side game outcome, the side game symbols being selected from a first symbol set comprising symbols that are playable in the game of roulette; randomly selecting a winning symbol for the game of roulette; and responsive to determining that the winning symbol matches one of the selected side game symbols, awarding a prize to each player who placed the side game wager based on a payout value assigned to the matching symbol and wherein the payout value is determined based, at least in part, on a number of winning symbol matches recorded for any of the selected side game symbols across a predefined number of preceding plays of the side game.

In accordance with yet another aspect there is provided a computer readable medium comprising computer program including at least one instruction which is arranged to implement the method as described in accordance with any of the preceding aspects.

An embodiment of the apparatus further includes a central control for running a gaming algorithm, and a plurality of remote clients in communication with the central control over a communications network, the remote clients including screens for the display of information to players.

Embodiments of the present invention may be applied in non-table based format on any suitable type of gaming system or platform. For example, they can be implemented by a stand-alone gaming apparatus, e.g. electronic gaming machines, such as video gaming machines, to gaming machines that are linked together, e.g. via a network such as an intranet, and/or to gaming systems provided through computing or other electronic devices, e.g. personal computers,

PDAs, mobile telephones, digital televisions, and the like, e.g. over the Internet or other communications networks.

### BRIEF DESCRIPTION OF THE DRAWINGS

Features and advantages of the present invention will become apparent from the following description of embodiments thereof, by way of example only, with reference to the accompanying drawings, in which:

FIG. 1 is a schematic block diagram of a gaming system, according to an embodiment of the present invention;

FIG. 2 is a schematic block diagram of operative components of a side game controller of the gaming system, according to an embodiment;

FIG. 3 is a flowchart of an embodiment;

FIG. 4 shows an example screen display showing side wager outcomes, in accordance with embodiment;

FIG. 5 is a plan view of a gaming table in accordance with an alternative embodiment; and

FIG. 6 shows an example screen display showing side wager game outcomes for the FIG. 6 embodiment.

### DETAILED DESCRIPTION

Embodiments described herein relate to a side wager game for a game of roulette. The side game is played concurrently with the game of roulette and is won when a winning roulette symbol matches one of a plurality of side game symbols drawn by a side game controller, as will be described in more detail in subsequent paragraphs. It will be understood that embodiments may be implemented either in table form (i.e. where wagers are placed on a physical wager table operated by a croupier), or in a virtual form (e.g. played in an automated fashion on an electronic gaming machine, or the like).

If the side game results in a winning outcome, players who placed a side bet wager (hereafter “bet”) are awarded a prize. A value of the prize is determined by evaluating a pay table listing payout values for the selected side game symbols.

In a particular form, the payout values are set for each play of the side game such that at least one of the selected side game symbols is assigned a payout value which is consistently offered for each game (hereafter referred to as a “fixed payout value”), while another of the selected symbols is assigned a payout value (hereafter variable payout value) which is selected from a predefined set of payout values. At least one of the payout values in the variable payout value set has a substantially greater value than the largest fixed payout value and is referred to herein as a bonus payout value. The selection of the variable payout value is made such that the bonus payout value is only selected infrequently (e.g. one in every 5 games), so as to maintain the house advantage over a series of plays of the side game. Expressed another way, the value of the variable payout is ordinarily set to the lower of the selectable payout values but on a random basis (e.g. for 20% of the game plays) is replaced with the larger bonus payout value.

Typically, the bonus payout value will be in the order of 2 or more times the value of the next largest payout value in the set.

Embodiments of the side game may thus advantageously offer players the opportunity to participate in a roulette side game which offers the possibility of a large bonus payout of a similar magnitude to poker or Sic Bo. Embodiments may also advantageously offer smaller “fixed value” payouts at a higher frequency thereby maintaining both the house advantage and player interest in the side game.

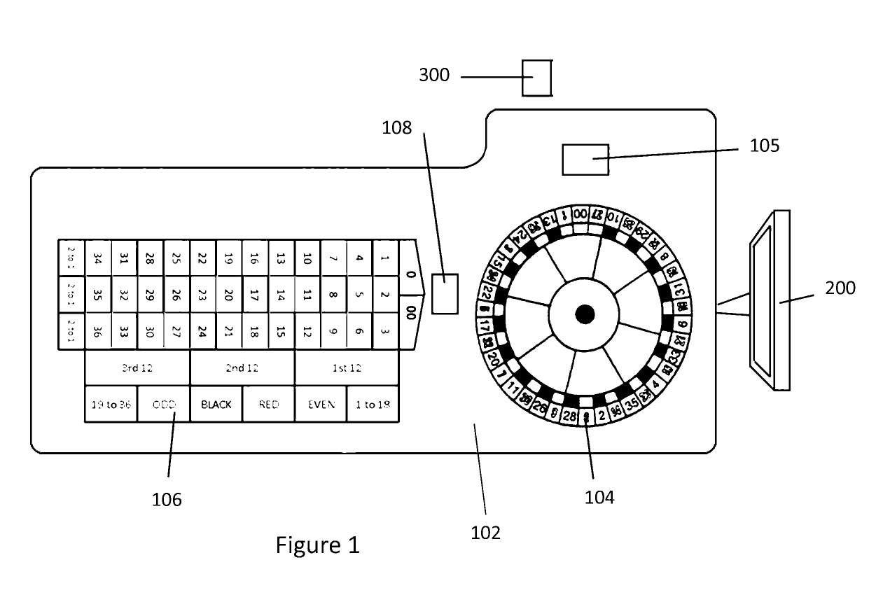

A physical “table based” embodiment of the present invention is shown in FIG. 1. A roulette table 102 is provided for accepting player wagers, while a roulette wheel 104 (in this case mounted on the table 102) is provided for selecting a winning roulette symbol, using techniques well known in the art. According to the illustrated embodiment, the roulette wheel 104 includes 37 colored (i.e. red and black) and number pockets for facilitating play of a single zero roulette game. It will be understood, however, that the wheel 104 could equally be configured for other styles of roulette (e.g. double zero style, etc.), depending on the desired implementation.

A surface of the roulette table 102 provides a designated primary betting area 106 displaying conventional roulette wager options. A side bet area 108 is designated for accepting side game bets, in this case taking the form of a rectangular box located adjacent the straight up bet. It will be understood that the shape and location of the side bet area 108 may vary depending on the desired implementation. Ideally the side bet area 108 will be in a convenient location for all players to reach and for the croupier to clear and payout bets. In a particular embodiment the side bet area 108 is provided at each end of the table 102 for convenient access to all players. Alternatively, players who find it difficult to reach the designated betting area 108 may place a “call bet” by asking the croupier to place their wager onto the designated side wager betting area 108.

An electronic display 200 (hereafter “winning number display) is situated near the table 102 and is operable to display outcomes of both the roulette game and the side game. In this regard, the display 200 is electronically coupled to a gaming controller 300 which is operable to determine the side game outcomes and control the display 200 to display said outcomes.

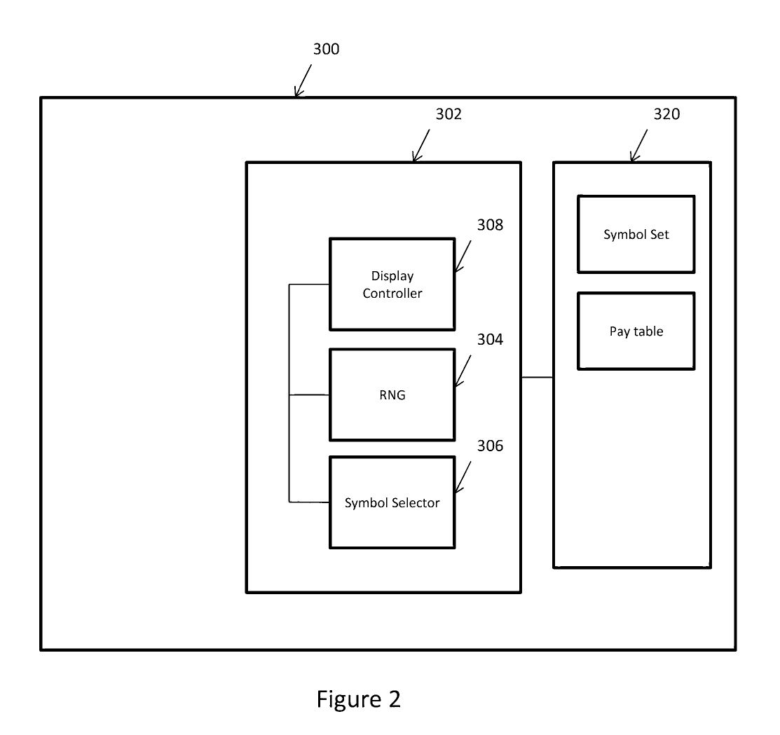

With additional reference to FIG. 2, the gaming controller 300 includes a processor 302 which is arranged to carry out the afore-mentioned side game functionality.

It will be apparent that the processor 302 implements a number of modules including a random number generator (RNG) module 304, symbol selector module 306 and display controller module 308, based on program code stored in memory 320. The modules may be implemented as software, hardware or a combination of the two.

The set of symbols selectable in the side game (in the illustrated embodiment taking the form of numbered and colored balls corresponding to the colored and number pockets of the roulette wheel 104), as well as the payout values offer able in the side game are stored in memory 320.

In a particular embodiment the symbol selector module 306 is programmed to randomly select, with the aid of the RNG 304, a predefined number of symbols from the symbol set for use in determining an outcome of the side game (as previously described a winning outcome occurs when one of the selected side game symbols is determined to match the winning roulette symbol, while a losing outcome occurs when there are no matches). Each of the selected symbols is assigned one of the payout values stored in memory 320.

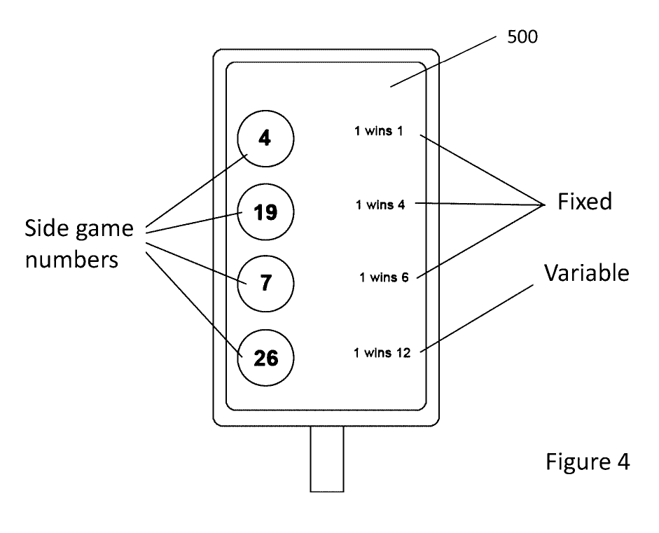

According to the embodiment illustrated in FIG. 4, the symbol selector module 306 is programmed to randomly select four side game symbols from the symbol set (although it will be understood that a fewer or greater number of symbols may be selected for determining the side game outcome, depending only on the desired implementation). In this embodiment, the first three symbols selected by the symbol selector module 306 are subsequently assigned different “fixed” payout values by the controller 300 (i.e. payout values which are consistently offered for each play of the game). The fourth payout value is assigned a payout value from a variable payout set by the controller 300.

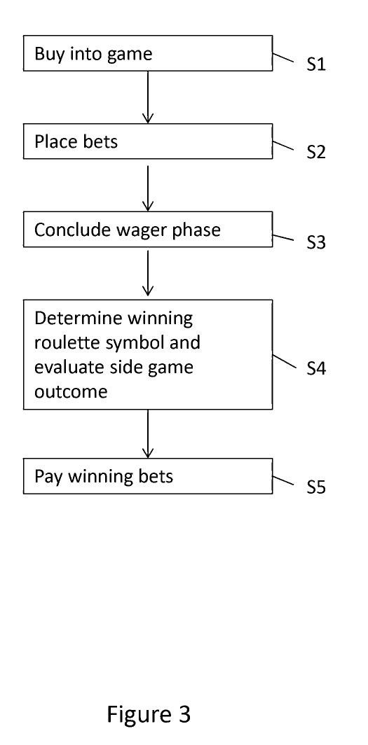

A process flow illustrating game play for a particular embodiment will now be described with reference to FIGS. 3 and 4.

At step S1, a player approaches the table 102 and buys into the roulette game in a conventional manner (i.e. by placing cash on to the table and requesting that the croupier issues them with wheel checks in exchange). As persons skilled in the art will understand, wheel checks are a form of chip designated for play on a particular table and color coded per player. Cash chips may also be requested for play of the roulette game.

At step S2, a wager phase for the game is initiated and the croupier may announce “place your bets”. In a particular embodiment, bets may be placed while the croupier is paying out bets from the previous game, provided the new bets are not within the vicinity of the previous game's winning results.

During the wager phase players are able to place bets on any one of the potential roulette outcomes (i.e. by placing wheel checks/chips on the desired bet within the first betting area 106). Additionally, or alternatively, players may place a side game bet (i.e. by placing a desired number of wheel checks or cash chips within the side bet area 108).

It will be understood that players may be able to place a side bet as soon as the last game side bets have been resolved (i.e. either by the croupier removing the losing bets or paying out winning bets).

The winning number display 200 is controlled to display outcomes of recent games which players may refer to help them decide which bets to place on the roulette game. A section of the display 200 is dedicated to the display of side game related information, including a listing of recently matched side game symbols.

At step S3, the croupier spins the ball in the roulette wheel 104. A short time later the ball in the wheel 104 slows down and the croupier announces “no more bets”, thereby concluding the wager phase. The symbol selector module 306 of the display controller 300 is initiated (either automatically based on an output from the no more bets sensor integrated into the roulette wheel, or manually based on a signal generated by the croupier) and four symbols are randomly selected for determining the outcome of the side game. It will be understood that other technologies could be implemented for initiating the symbol selector module 306, including cameras mounted to the roulette wheel 104 and other light sensing technologies currently used in casinos. It will also be understood that in a particular embodiment the selection of side game symbols could occur during the wager phase. In a particular embodiment either the assigned variable payout value (discussed below) and/or selected side game symbols will not be displayed until after the wager phase has concluded.

Below is an example payout table (Table 1) for a side game in accordance with an embodiment, illustrating the different fixed and variable payout values offered in the side game.

TABLE 1
Payout Table

| Symbol Number | Payout Value |
|---|---|
| First selected symbol | 1:1 (fixed) |
| Second selected symbol | 4:1 (fixed) |
| Third selected symbol | 6:1 (fixed) |
| Fourth selected symbol | 12:1, 50:1 (variable payout value set) |

For the above payout table a weighting is applied to the selection of the variable payout value, such that the 50:1 payout value (i.e. in this case being the bonus payout value) is selected on average once in every five games. It will be understood that any desired weighting could be applied to the different payouts in the variable payout set, and that more than two variable payout values could be available for selection by the controller 300, depending only on the desired implementation and house advantage. It will also be understood that the actual routine implemented for determining the variable payout value to select could also vary. By way of example only, the RNG 304 could be implemented to randomly select a number between 1 and 10 for each game play, such that the bonus payout value is only selected where the randomly selected number is less than or equal to 2 (i.e. otherwise the lower payout value in the set will ordinarily be selected). Again, the range and threshold number could vary depending on the desired outcome.

It will also be understood that the above payouts do not represent the actual probability that the selected symbol will match the roulette winning number. Indeed, according to this embodiment each of the randomly selected side game numbers has an equal chance of being a match with the outcome generated by the roulette wheel (i.e. such that each said number has a different payout and said payout bears no correlation with the chances of the winning number being the same as the number associated with said payout). Instead the payout values are set such that a desired house advantage is achieved across a series of games. In a particular embodiment the highest variable payout may be equivalent to the payout achievable for table based games such as Casino poker and Sic Bo.

It will also be understood that the variable payout set may include a plurality of bonus payouts of different value and that each of these bonus payouts may have a different probability of being selected for use in any one play of the side game. By way of example only, the variable payout set may include an ordinary payout value of 12:1 with an 80% probability of being selected, a minor bonus payout value of 50:1 with a 19% probability of being selected and a major bonus payout value of 100:1 with a 1% probability of being selected.

With reference to FIG. 4 there is shown a screen image 500 output by the display 200 showing four numbered balls (i.e. side game symbols) selected by the controller 300 for determining the side game outcome. The numbered balls are displayed in association with their assigned payout value. In this case the uppermost numbered ball is labelled “1 wins 1”, the second ball down is labelled “1 wins 4”, the third ball is labelled “1 wins 6” and the bottommost ball is labelled “1 wins 12”. If the outcome of the roulette game matches one of the four numbered balls, all players who placed a side bet will be paid the corresponding labelled payout value.

In a particular embodiment the display 200 is controlled by the gaming controller 300 to show an animation of the four numbered balls being dropped and coming to rest in the vertical column.

At step S4, the roulette ball drops to determine the winning number for the roulette game, responsive to which the croupier places a dolly onto the winning number in the primary betting area 106 of the game table 102 and proceeds to take the losing bets and pay the winning bets. If the winning number matches any of the four side game numbers shown on the display 200, the croupier will pay all of the side game bets according to the payouts assigned to the matching side game number.

In a particular embodiment, the gaming controller 300 is communicable with electronic circuitry implemented by the roulette wheel 104 for determining the winning roulette number. Alternatively, the winning roulette number may be keyed in to the controller by the croupier. The display controller 300 is then operable to automatically determine the side game outcome (i.e. match or no match) for display. Responsive to determining a winning outcome, the gaming controller 300 may cause the display 200 to display a winning animation.

At step S5, the croupier finishes paying the winners and announces, “place your bets” and game play returns to step S I. The four numbered balls from the previous game are erased from the display 200.

In a particular embodiment, the symbol set comprises a subset of the symbols which are playable in the game of roulette. For example, the subset may comprise only even numbers, odd numbers, red numbers, black numbers, or any desired subset. In a particular embodiment the subset may consist only of “hot” numbers, i.e. numbers which have been drawn in the roulette game more than some predefined number of times within some predefined number of games (e.g. numbers drawn two or more times in the last 10 games). Equally, the subset may consist only of “cold” numbers, i.e. numbers that have been drawn less than some predefined number of times within some predefined number of games (e.g. numbers that have not been drawn within the last 10 games).

In a particular embodiment, one or more of the numbers may be consistently selected for each side game, while the remaining numbers are randomly selected. For example, the number “8” (which is considered to be a lucky number in Asian culture) may be consistently selected for each game, with the remaining three numbers randomly selected from the symbol set. In a particular embodiment the consistently selected number is always assigned the variable payout value from the pay table.

The symbol selector module 306 may be programmed such that the selected side bet symbols comprise the winning roulette symbol from the preceding game and at least one symbol located either side of the winning roulette symbol on the roulette wheel 104. For example, the symbol selector module 306 may be programmed to select five side bet symbols comprising the winning roulette symbol from the preceding game of roulette and the two symbols located on either side of the winning roulette symbol on the roulette wheel 104. According to a particular embodiment the variable payout value is assigned to the winning symbol from the preceding game, while the other symbols are assigned different fixed payout values.

In another alternative embodiment, certain numbers within the side game symbol set could have a different weighting to other numbers such that they are selected more frequently by the symbol selector module 306. For example, the numbers 3, 8, 9, 28 and 29 (which are considered to be lucky numbers for Asian players) could be weighted such that they are selected more frequently than each of the other numbers on the roulette wheel 104.

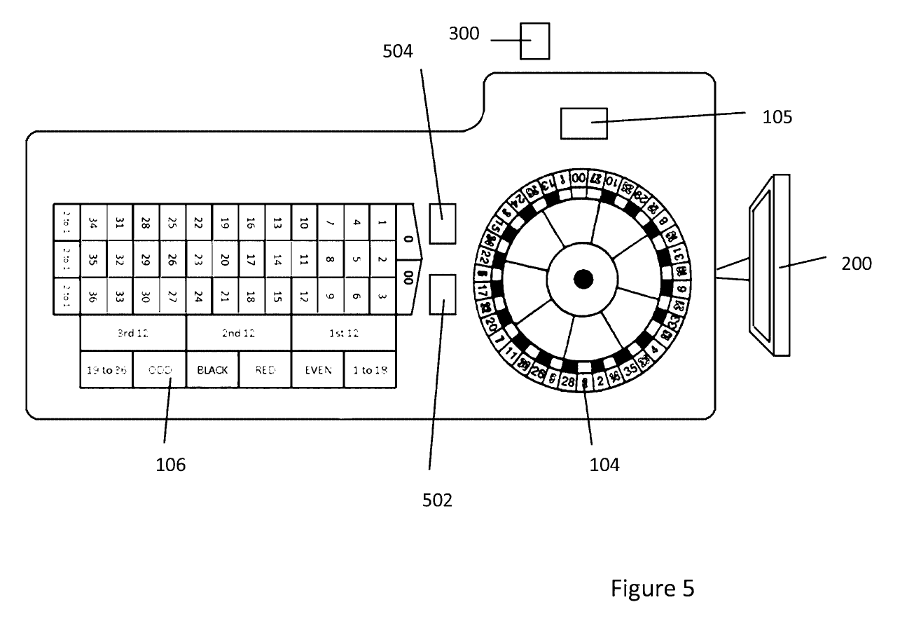

An alternative embodiment of the side game will now be described with reference to FIG. 5. According to this embodiment players are able to place a bet on one or both of two different side game outcomes. More particularly FIG. 5 shows a table layout which includes two alternative bet options for the side game, namely “red” or “black” (denoted by boxes 502, 504). Players can place a side game bet on either or both of the red and black outcome, in the same manner as previously described with reference to FIG. 3. According to this form of side game play, the symbol selector module 306 is programmed to select a predefined number of symbols from a symbol set containing only red numbers and another predefined number of symbols from a symbol set comprising only black numbers. Each of the selected numbers are then assigned by the controller 300 one of a fixed or variable payout value from a payout table, as previously described.

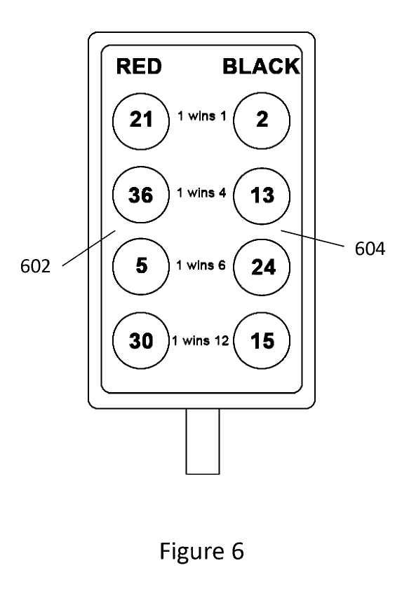

An example “four ball” selection is shown in FIG. 6, where the symbol selector module 306 is programmed to randomly select four red numbers for display in a red column 602 and four black numbers in a black column 604. The game proceeds in the same manner as previously described with reference to FIG. 3, i.e. such that if the winning roulette symbol matches either one of the selected red or black symbols all player bets placed on the corresponding side bet (i.e. red or black) are paid. If the winning number does not match any of the selected side game numbers or is zero then both red and black bets lose. Other variations on this form of side game include allowing players to place a side wager on odd and even numbers, hot and cold numbers, high and low numbers. Thus, the symbol selector module 306 is programmable to select a predefined number from each of two mutually exclusive symbol subsets.

Another alternative form of side game involves providing a pay table which may occasionally provide enhanced payouts, but otherwise remain fixed (e.g. on average once in every five plays the pay table may provide one or more enhanced fixed and/or variable payouts for matching symbols).

In an alternative form of side game play, the payout value for a matching side game symbol takes into consideration whether any of the other currently selected side game symbols match winning roulette symbols from a predefined number of preceding plays of the roulette game. The predefined number of preceding plays of the side game may, for example, be equal n−1 where n is the total number of selected side game symbols. In a particular embodiment, the payout value will increase relative to the number of matches for the other symbols. For example, where all symbols other than the currently matched symbol match winning roulette symbols from a corresponding number of preceding games a jackpot payout value (i.e. a particularly high payout value) may be assigned to the matching symbol in the current game. A lesser payout value may be assigned where only some of the other side game symbols match winning symbols from the immediately preceding games. An example pay table is shown below for a four ball side game (noting that the payouts below are examples only and should not be seen as being limiting in any way).

TABLE 2

| No. balls matched over last four games | Payout Value |
|---|---|
| 1 (i.e. current ball only) | 5:1 |
| 2 | 10:1 |
| 3 | 100:1 |
| 4 | 5,000:1 (jackpot) |

A worked example for the above example paytable will now be given. In this example four side game symbols are generated by the symbol selector module 306 following the conclusion of the wager phase. A payout value of 5:1 is awarded where one of the selected side game symbols matches the current roulette game winning symbols and increases in value if any of the remaining side game symbols match winning roulette symbols from any of the prior three game games. Thus, if none of the remaining side game symbols match winning roulette symbols from the prior three games the payout value assigned to the currently matching symbol is 5:1. If one of the remaining side game symbols matches a winning roulette symbols from one of the prior three games then a payout of 10:1 is assigned/awarded. If two of the remaining side game symbols match winning roulette symbols from the preceding three games then a payout of 100:1 will be awarded. If each of the three remaining symbols match the three winning roulette symbols from the preceding three games, then a jackpot pay of 5000:1 is awarded. In a particular embodiment, each side game symbol, when matched with a winning roulette symbol, is not available for matching with any other prior game or the current game.

In yet another alternative form of side game play, the selected side game symbols correspond to winning symbols from recent roulette games. For example, for a five ball side game, the side game symbols comprise winning symbols from the last five roulette games. If any winning roulette symbol occurred twice within the prior five games, it would be required to draw on winning symbols from earlier games until a unique side game symbol set is achieved. In the case of an unusual run of results it can be seen that the side game symbols may require to be drawn from six, seven or more of the most recent prior games in order to comprise a set of four unique numbers.

Although the afore-described embodiments were described in the context of a venue based game it will be understood that alternative embodiments may involve players remotely participating in the game. For example, the gaming controller 300 could be configured to communicate over any suitable network such as an intranet, and/or to gaming systems provided through computing or other electronic devices, e.g. personal computers, PDAs, mobile telephones, digital televisions, and the like, e.g. over the Internet or other suitable communications networks.

It will be understood that the embodiments described above should not be seen as being limited for play on a physical casino table and instead could readily be implemented as a screen based game, e.g. playable on an electronic gaming machine EGM, as an Internet-based game or the like. In this regard an electronic game controller implemented by a computer server may be used to receive player bets, control game play and award winning pays.

The afore-mentioned embodiments provide a new form of roulette side game that may provide significantly higher payouts than are achievable in a standard roulette game, in a manner that is easily understood and transparent to the players. Furthermore, there is no requirement that players must also participate in the primary roulette game. Other notable advantages of particular embodiments include:

the ability to base side bet outcomes on inherent features of the main roulette game (i.e. roulette number winning results);

the ability to provide a side bet game which does not obscure, interfere or change the way in which the main roulette game is played;

a side game which has minimal impact on dealing staff and game operations;

a side game which will not put off more serious players who want to concentrate on the main roulette game;

a side game having a pay table which is easily adjusted and optimized for providing a house advantage; and

a side game which is frequently won and whereby the hit frequency can be readily adjusted by simply adding more or less side wager options.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method of conducting play of a side game which is concurrently playable with a live table game of roulette and such that an outcome of the side game can be determined during the same single spin cycle as the live game of roulette, the method comprising:
during a wager phase for the game of roulette, accepting side bet wagers from players in respect of a first side game, the side bet wagers being independent of wagers placed on the roulette game, both the wagers placed on the live table roulette game and the side bet wagers being received on a physical wager table associated with the live table game of roulette and wherein the side bet wagers a placed in a designated side bet wager zone separate to a primary wager zone in which the wagers for the roulette game are placed;
an electronic game controller implementing a symbol selection module configured to:
(a) select two or more side game symbols from a first symbol set comprising symbols that are playable in the game of roulette, the selection being made utilising a random number generator;
(b) assign each of the selected side game symbols a payout value, such that at least one of the assigned payout values is a fixed payout value utilised for each play of the side game and a single one of the other assigned payout values is a variable payout value and wherein the variable payout value is selected from a set of payouts including a bonus payout value which is of substantially greater value than the other payout values in the set and wherein the selection of variable payout value is made such that the bonus payout value has a lower likelihood of being selected than the other payout value(s) in the set;
displaying the selected side game symbols and their assigned payout value on an electronic display screen that is visible to each of the players;
determining a winning symbol for the game of roulette based on a single spin of either a live or virtual roulette wheel associated with the live table game of roulette;
determining whether the winning symbol matches any of the selected side game symbols; and
responsive to determining that the winning symbol matches one of the selected side game symbols, awarding a side game prize to each player who placed a side bet wager according to the corresponding assigned payout value in the same single spin cycle as the live table game of roulette; and wherein the electronic display screen is additionally configured to display one or more recently matched side game symbols.

2. The method in accordance with claim 1, further comprising displaying on a display screen associated with the live table game of roulette the variable payout value and/or selected side game symbols after the wager phase has concluded and during the same single cycle as the live table roulette game.

3. The method in accordance with claim 1, wherein the selected side game symbols are displayed on a display screen associated with the live table game of roulette after the wager phase has concluded and before the winning symbol for the game of roulette is drawn.

4. The method in accordance with claim 1, wherein the first symbol set comprises a subset of the symbols which are playable in the game of roulette.

5. The method in accordance with claim 1, wherein at least one of the selected side game symbols is randomly selected from the first symbol set.

6. The method in accordance with claim 5, further comprising applying a weighting to the random selection of side game symbols such that at least one of the symbols in the first symbol set is more likely to be selected than another of the symbols.

7. The method in accordance with claim 6, wherein one of the symbols in the first symbol set is selected for each play of the side game.

8. The method in accordance with claim 7, wherein the one symbol selected for each play of the side game is assigned the variable payout value.

9. The method in accordance with claim 1, further comprising accepting side bet wagers from players on an alternative side bet outcome, the alternative side bet outcome determined by selecting an additional two or more symbols from a second symbol set, wherein the first and second symbol sets comprise a mutually exclusive subset of symbols that are playable in the game of roulette and wherein responsive to determining that the winning symbol matches one of the additional symbols players that placed side bet wagers on the alternative side bet outcome are awarded a side bet prize.

10. The method in accordance with claim 9, wherein the first symbol set comprises a selection of symbols determined as winning symbols at least a predefined number of times within a preceding predefined number of games, the predefined number of times and games each being greater than 1.

11. The method in accordance with claim 9, wherein the second symbol set comprises a selection of symbols that have been determined as winning symbols less than or equal to a predefined number of times within a preceding predefined number of games.

12. The method in accordance with claim 1, wherein the selected side bet symbols comprise the winning roulette symbol from the preceding game and at least one symbol located either side of the winning roulette symbol on the roulette wheel.

13. The method in accordance with claim 12, further comprising the symbol selection module selecting five side bet symbols comprising the winning roulette symbol from the preceding game of roulette and the two symbols located on either side of the winning roulette symbol on the roulette wheel.

14. The method in accordance with claim 12, further comprising the symbol selection module allocating the variable payout value to the winning symbol from the preceding game.

15. The method in accordance with claim 13, further comprising the symbol selection module allocating each of the symbols located on either side of the winning symbol fixed payout values.

16. The method of conducting play of a side game which is concurrently playable with a live table game of roulette and such that an outcome of the side game can be determined during the same single spin cycle as the live table game of roulette, the method comprising:
during a wager phase for the game of roulette, accepting side game wagers from players, both the wagers placed on the roulette game and the side bet wagers being received on a physical wager table associated with the live table game of roulette;
an electronic game controller implementing a symbol selection module configured to:
a) select two or more side game symbols for use in determining the first side game outcome, the side game symbols being selected from a first symbol set comprising symbols that are playable in the game of roulette;
b) assign a payout value to each selected side game symbol, each payout value being randomly selected from a respective set of payouts having values within a predefined range and wherein at least one of the respective sets has a different predefined range to another of the sets and wherein at least one of the sets includes a bonus payout value which is of substantially greater value than: (a) any other payout values in the corresponding set; and (b) any payout values in each of the other sets; and wherein a likelihood of selecting the bonus payout value from the corresponding set is lower than the likelihood of selecting any one of the other payout values in the corresponding set;
determining a winning symbol for the game of roulette based on a single spin of either a live or virtual roulette wheel associated with the live table game of roulette; and
displaying the selected side game symbols and their assigned payout value on an electronic display screen that is visible to each of the players;
responsive to determining that the winning symbol matches one of the selected side game symbols, awarding a prize to each player who placed the side game wager according to the payout value corresponding to the matched side game symbol in the same single spin cycle as the live table game of roulette.

17. An apparatus for facilitating play of a side game which is concurrently playable with a live table game of roulette and such that an outcome of the side game can be determined during the same single spin cycle as the live table game of roulette, the apparatus comprising:
a wager table for receiving side bet wagers from players during a wager phase of the live table game of roulette;
a physical or virtual roulette wheel for determining a winning roulette symbol once the wager phase has concluded; and
an electronic gaming controller operable to select two or more side game symbols, the side game symbols being selected from a first symbol set comprising symbols that are playable in the game of roulette, the gaming controller being further operable to assign each of the selected symbols a payout value such that at least one of the assigned payout values is a fixed payout value utilised for each play of the side game and another of the assigned payout values is a variable payout value and wherein the variable payout value is selected from a set of payouts including a bonus payout value which is of substantially greater value than the other payout values in the set and wherein the selection of variable payout value is made such that the bonus payout value has a lower likelihood of being selected than the other payout value(s) in the set, wherein responsive to determining that the winning symbol matches one of the selected side game symbols, displaying the selected side game symbols and their assigned payout value on an electronic display screen that is visible to each of the players, a prize is awarded to each player who placed the side game wager according to the payout value assigned to the matching symbol in the same single spin cycle as the live table game of roulette.
